(19) United States
(12) Patent Application Publication
(10) Pub. No.: US 2012/0039483 A1
(43) Pub. Date: Feb. 16, 2012

(54) AUDIO SYSTEM FOR SKATEBOARDS

(75) Inventors: David BURKE, Henryville, PA (US); Kirk LOMBARDO, Milford, PA (US); Christopher KING, Milford, PA (US)

(73) Assignee: ALTEC LANSING, LLC, Milford, PA (US)

(21) Appl. No.: 13/026,958

(22) Filed: Feb. 14, 2011

Related U.S. Application Data
(60) Provisional application No. 61/304,166, filed on Feb. 12, 2010.

(51) Int. Cl. H04R 1/00; B62M 1/00

(52) U.S. Cl. 381/86; 280/87.042

(57) ABSTRACT

A audio system for skateboards comprising an audio module and speakers mounted to the bottom side of a skateboard. The audio module is battery-operated and has a Bluetooth receiver and a stereo amplifier. The speakers face downwards. While the rider is traveling on the skateboard, the sound from the speakers bounces back from the road's surface so that the rider may enjoy music in safe manner without loss of maneuverability.

This application claims priority to U.S. Provisional Patent Application No. 61/304,166 filed Feb. 12, 2010, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of audio systems, and in particular to a portable music system for skateboarding.

### BACKGROUND OF THE INVENTION

Teenagers represent an important segment of the music listening market. One of the popular pastimes of this age group is skateboarding, particularly longboarding. One of the problems that currently exists is listening to, and/or sharing, music while riding in a safe manner.

One partial solution is listening to a portable MP3 player via headphones. There are, however, drawbacks. For one, such devices do not allow the sharing of music. Another drawback is the safety hazard created by blocking sounds of traffic, alarms, etc.

Boomboxes are generally stationary and limit the listener's boundaries of how far they can ride. A boombox carried by a rider on a skateboard/longboard presents a dangerous scenario. It impairs the user's balance and ability to react to unexpected events, such as cars, pedestrians, hazardous terrain, etc.

Similarly, mounting an universal boombox or similar device onto the skateboard/longboard platform results in drivability restrictions. Additionally equipment impedes the rider's ability to maneuver the board and/or do tricks. Further, it may lead to potential accidents and damage to the mounted equipment, the board, and the surrounds.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates bottom perspective view of a portable music system attached to a skateboard in accordance with certain embodiments of the invention.

FIG. 2 illustrates side perspective view of a portable music system attached to a skateboard in accordance with certain embodiments of the invention.

FIG. 3 illustrates bottom perspective view of the right side of a portable music system attached to a skateboard in accordance with certain embodiments of the invention.

FIG. 4 illustrates bottom perspective view of the left side of a portable music system attached to a skateboard in accordance with certain embodiments of the invention.

FIG. 5 illustrates side perspective view of the left side of a portable music system attached to a skateboard in accordance with certain embodiments of the invention.

FIG. 6 illustrates side perspective view of the right side of a portable music system attached to a skateboard in accordance with certain embodiments of the invention.

### DETAILED DESCRIPTION OF EMBODIMENTS OF THE INVENTION

Reference will now be made in detail to embodiments of the present invention, examples of which are illustrated in the accompanying drawings.

In an embodiment, skateboard riders may safely enjoy and share music while riding their skateboard/longboard.

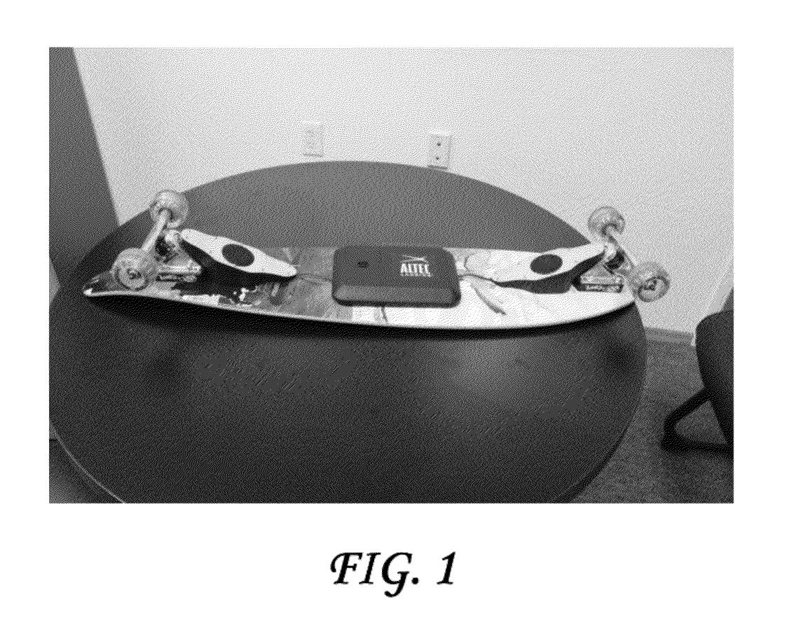

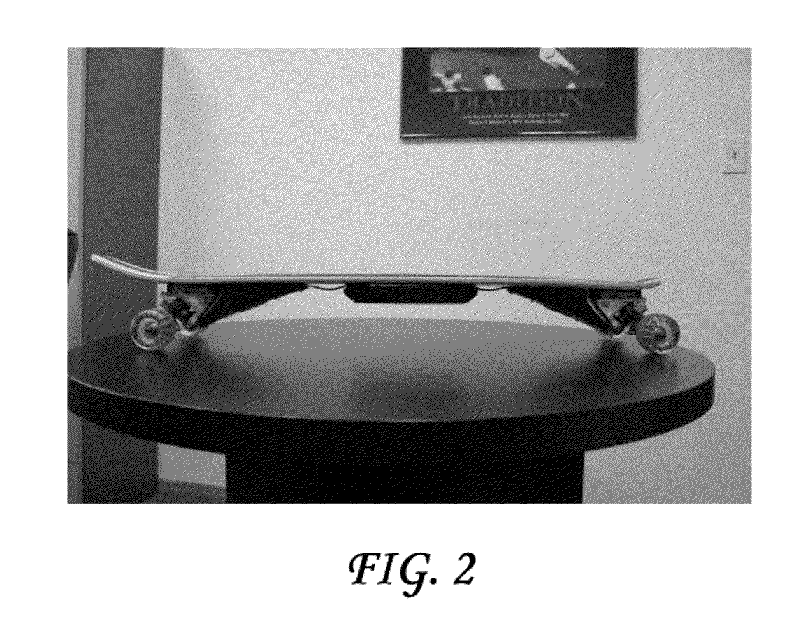

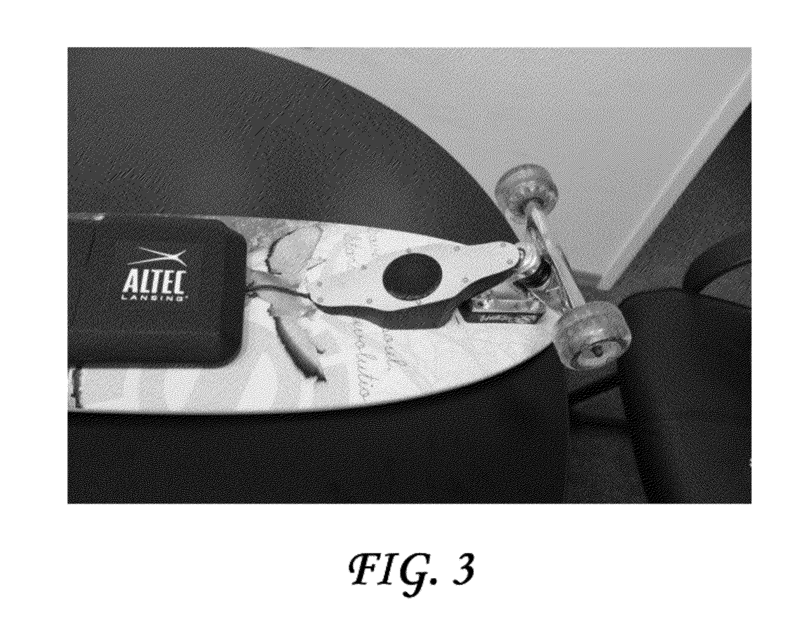

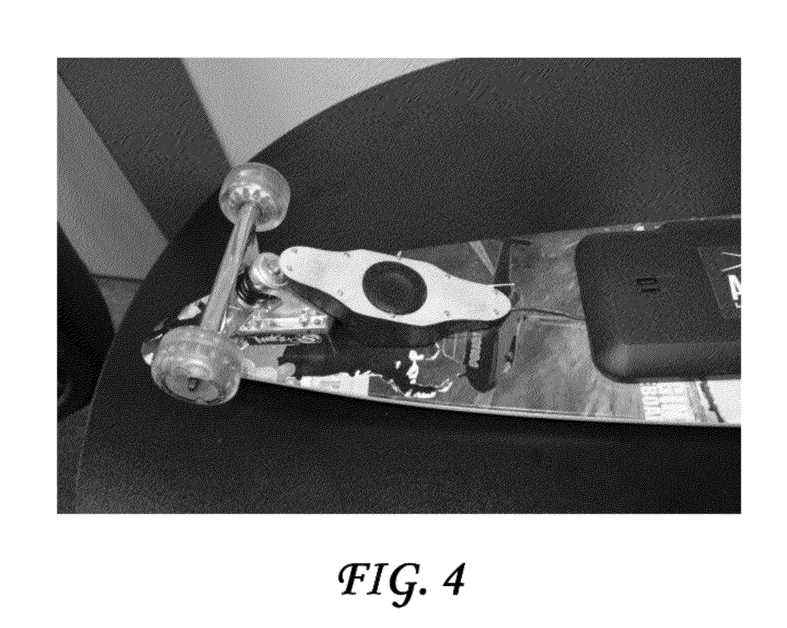

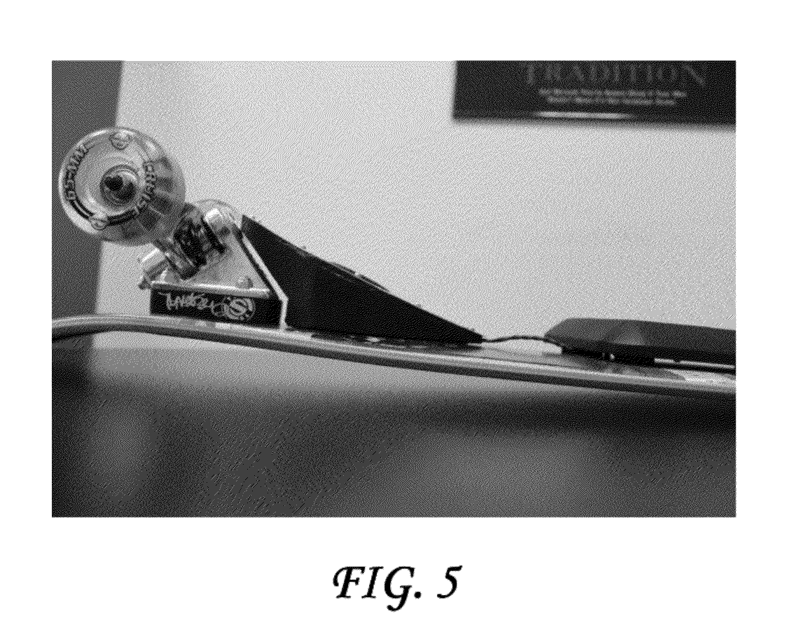

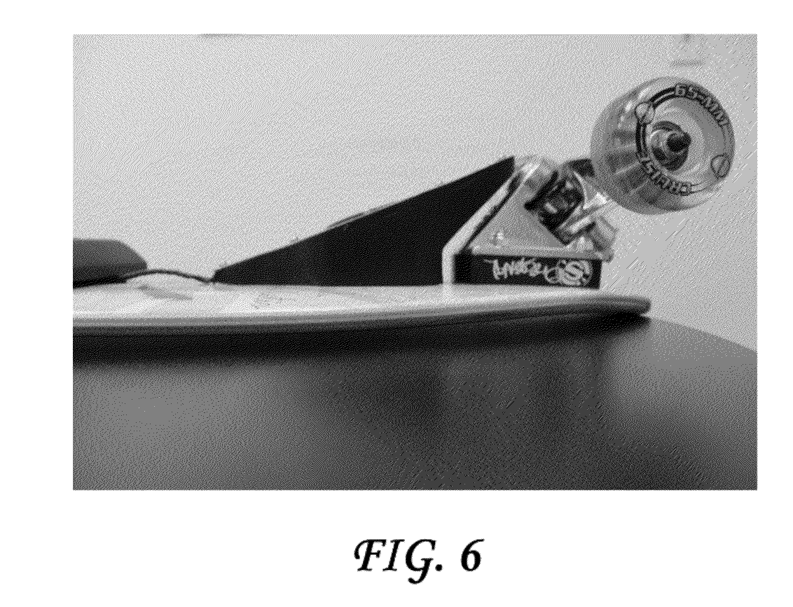

With reference to FIGS. 1-6, a pair of stereo speakers are mounted under the skateboard/longboard. The speakers can be mounted inside the trucks, angled downward and away from the trucks. The speakers are connected to a battery-operated module, which is also mounted under the center of the skateboard. The battery-operated module comprises a stereo Bluetooth receiver and stereo amplifier.

The shape of the speakers and their mounting position allows maximum acoustic volume without impeding the movement of the trucks (wheels/axles) or affecting the flexibility of the skateboard.

The mounting of the components are designed such that the mounting screws are in a straight line along the center of the skateboard, thereby not affecting the left/right performance and/or maneuverability.

The components are mounted a short distance off the surface of the skateboard with compressed foam between the board and the component. This allows flexing of the board without breaking the components or impeding the board's maneuverability.

The rider can wirelessly connect/pair his music player to the speaker system and control the playback of the music. The music player may comprise any wireless and/or Bluetooth enabled music source, including but not limited to a phone, IPod, PDA. Because the speakers are facing downward, the music is always traveling along with the skateboard, and uses the road's surface to bounce the sound back up for the rider (and others) to hear. This allows the enjoyment and sharing of music safely, and without impeding the rider's ability to maneuver his skateboard.

Music may be played via the battery-operated module from Bluetooth enabled devices of other persons that traveling with along with the rider. Such persons may be riding on other skateboards, bicycles, rollerblade, etc.

The skateboard can also be used as a “boombox” when not riding, by carrying it on your shoulder like a conventional boombox.

While the invention has been particularly shown and described with reference to a preferred embodiment thereof, it will be understood by those skilled in the art that various changes in form and details may be made therein without departing from the spirit and scope of the invention. The above embodiments are illustrative of the present invention. It is neither necessary, nor intended for this patent to outline or define every possible combination or embodiment. The inventors have disclosed sufficient information to permit one skilled in the art to practice at least one embodiment of the invention, and has disclosed the ways the inventor now believes are the best ways to practice the invention. The variations to the present invention include variation in the audio transmission protocol and the configuration of the speakers and/or audio components.

The embodiments of the invention in which an exclusive property or privilege is claimed are defined as follows:

1. An audio system for skateboards, comprising:
an audio module adapted to be mounted on the bottom side of a skateboard, the audio module having a receiver and an amplifier;
at least one speaker connected to the audio module.

2. The audio system of claim 1, wherein the audio module is battery-operated.

3. The audio system of claim 1, wherein the audio module is mounted at the center of the skateboard.

4. The audio system of claim 1, wherein the receiver is a Bluetooth receiver.

5. The audio system of claim 1, wherein the at least one speaker comprises of two speakers and the amplifier is a stereo amplifier.

6. The audio system of claim 1, wherein the at least one speaker is angled downward and away from an axle of the skateboard.

7. The audio system of claim 1, wherein the audio module is mounted on the skateboard via a flexible adhesive.
